(19) United States
(12) Patent Application Publication
(10) Pub. No.: US 2011/0262842 A1
(43) Pub. Date: Oct. 27, 2011

(54) SYSTEM AND METHOD FOR STORING AND DISCHARGING HEAT IN A VEHICLE

(75) Inventors: Jun Yang, Ann Arbor, MI (US); Shinichi Hirano, West Bloomfield, MI (US); Clay Wesley Maranville, Ypsilanti, MI (US)

(73) Assignee: Ford Global Technologies, LLC, Dearborn, MI (US)

(21) Appl. No.: 12/767,854

(22) Filed: Apr. 27, 2010

(51) Int. Cl. H01M 8/04; H01M 8/24

(52) U.S. Cl. 429/515; 429/452; 429/436

(57) ABSTRACT

In at least one embodiment, an apparatus comprising a hydrogen storage system and a heat storage system is provided. The hydrogen storage system is configured to store hydrogen and to deliver a first heated fluid stream to an electrical generation system that generates a second heated fluid stream and electrical energy in response to the first heated fluid stream. The heat storage system includes a phase change material. The heat storage system is in fluid communication with the electrical generation system to deliver heat from the second heated fluid stream to a fuel cell stack.

### BACKGROUND

1. Technical Field

The embodiments of the present invention generally relate to, among other things, a system and method for storing and discharging heat in a vehicle.

2. Background Art

Hydrogen can be used as fuel for a fuel cell based vehicle. It is known that while storing hydrogen in a tank of the vehicle (e.g. during refueling), a large amount of heat may be generated. It is also known to remove the heat from the tank in moments in which hydrogen is being stored in the tank. Such extracted heat may be used to heat the fuel cell during fuel cell operation. In addition, the extracted heat may be used to release the hydrogen from the tank during fuel cell operation, as heat is needed to assist in releasing hydrogen from the tank for the purpose of transferring the hydrogen to the fuel cell.

### SUMMARY

In at least one embodiment, an apparatus comprising a hydrogen storage system and a heat storage system is provided. The hydrogen storage system is configured to store hydrogen and to deliver a first heated fluid stream to an electrical generation system that generates a second heated fluid stream and electrical energy in response to the first heated fluid stream. The heat storage system includes a phase change material. The heat storage system is in fluid communication with the electrical generation system to deliver heat from the second heated fluid stream to a fuel cell stack.

### BRIEF DESCRIPTION OF THE DRAWINGS

FIG. 1 depicts a system for storing and discharging heat in a vehicle in accordance to one embodiment of the present invention;

FIG. 2 depicts a heat storage system in accordance to one embodiment of the present invention;

FIG. 3 depicts a system for storing and discharging heat in a vehicle in accordance to one embodiment of the present invention; and

FIG. 4 depicts a system for storing and discharging heat in a vehicle in accordance to one embodiment of the present invention; and

FIG. 5 depicts a system for storing and discharging heat off-board the vehicle in accordance to one embodiment of the present invention.

### DETAILED DESCRIPTION

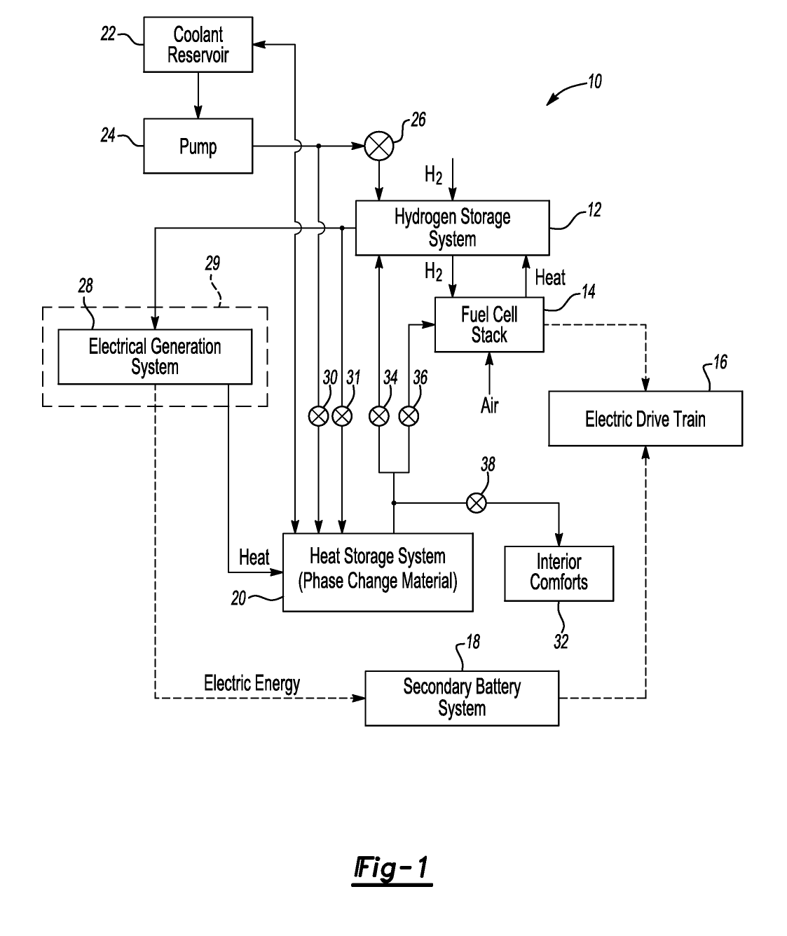

FIG. 1 depicts a system 10 for storing and discharging heat in a vehicle in accordance to one embodiment of the present invention. The system 10 includes a hydrogen storage system 12, a fuel cell stack 14, an electric drive-train 16, a battery system 18, and a heat storage system 20. The hydrogen storage system 12 stores hydrogen and is capable of providing the hydrogen as fuel to the fuel cell stack 14. The fuel cell stack 14 comprises a number of fuel cells that are joined together. The stack 14 generates electrical current in response to electrochemically converting hydrogen and oxygen (e.g., see air stream) into water. The electrical current (or power) generated in such a process is used to drive the electrical drive-train 16. The system 10 is generally defined as a parallel hybrid system in that either the fuel cell stack 14 can provide power to the electric drive-train 16 or the secondary battery system 18 can provide power to the electric drive-train 16.

Hydrogen is provided to the hydrogen storage system 12 during a refueling operation. It is known that a considerable amount of heat may be generated during the refueling operation. For example, reversible hydrogen storage materials included within the hydrogen storage system 12 release heat while the hydrogen is being absorbed into such materials. The amount of heat released generally depends on the type of storage materials used as exemplified by hydride formation enthalpy. In one example, the amount of heat that is released during refueling may be between 20 to 50 kJ/mol_H₂.

During the hydrogen refueling process, the large amount of heat that is generated may need to be extracted to maintain the hydrogen absorption kinetics via a heat exchanging mechanism that is constructed within the hydrogen storage system 12. For example, if the hydrogen storage material has a hydride formation enthalpy of 50 kJ/mol_H₂, for a storage system that holds 4 kg of hydrogen and needs to be refueled in 10 minutes, a total of 30×2000 KJ=60 MJ of heat has to be extracted within the recharging time of 10 minutes (e.g., 0.1 MW of heat flows out of the hydrogen storage system 12). In general, the temperature of the heat generally depends on the type of materials used for the storage materials. For conventional metal hydrides, the temperature can reach up to 85° C. when water is used as a coolant. For exothermic materials-based hydrogen generation, the temperature may go up to several hundred degrees (600° C.) in hydrocarbon reformation.

A coolant reservoir 22 that includes coolant (e.g., water or other suitable liquid) is fluidly coupled to the hydrogen storage system 12. A pump 24 receives the coolant from the coolant reservoir 22 to increase the flow of the coolant. A valve 26 receives the coolant from the pump 24 and controls the flow of the coolant into the hydrogen storage system 12. The hydrogen storage system 12 receives the coolant and is capable of discharging the heat (within the coolant) generated in response to refueling.

An electrical generation system 28 is fluidly coupled to the hydrogen storage system 12 and is configured to receive the coolant along with the discharged heat from the hydrogen storage system 12. A valve (not shown) may be positioned between the hydrogen storage system 12 and the electrical generation system 28 to control the flow of the heated coolant to the electrical generation system 28. The electrical generation system 28 is generally configured to generate electrical energy (current) in response to the heat. For example, the electrical generation system 28 may use a thermophotovoltaic device or a combination of a device that includes thermoacoustic and piezo-electric effects to generate energy. The implementation of either the thermophotovoltaic based device or the thermoacoustic and piezoelectric based device within the electrical generation system 28 varies based on the expected temperature of the coolant that is discharged from the hydrogen storage system 12. For example, a thermophotovoltaic based device could be incorporated into hydrocarbon hydrogen generation systems, where the coolant temperature may be above 600° C. A thermo-acoustic and piezo-electric based electricity generation system could be used to convert the heat (from within the coolant) that is received from the hydrogen storage system 12, where the coolant temperature ranges from several tens of degrees centigrade up to several hundred degrees centigrade.

Thermophotovoltaic (TPV) is generally defined as a class of power generating systems that are used to convert thermal energy into electrical energy. TPVs include may include an emitter, a photovoltaic power converter, concentrators, filters and reflectors. The operation of thermophotovoltaics is similar to that of traditional photovoltaics. With traditional photovoltaics, a p/n junction is used to absorb optical energy, to generate and separate electron/hole pairs, and to convert that energy into electrical power. In thermophotovoltaics, the emitter generates the optical energy in response to a high temperature. The thermal energy (e.g., in the coolant received from the hydrogen storage system 12) enables the thermophotovoltaics to generate the electrical energy based on the thermal energy.

A thermo-acoustic device is generally defined as a device that generates acoustic vibrations due to a temperature gradient across the device that is filled with pressurized gas. Piezo-electric device is generally defined as a device that utilizes the ability of materials to generate an electric field or electric potential in response to an applied mechanical stress. The thermoacoustic-piezoelectric based device uses the heat from the coolant (e.g., coolant received from the hydrogen storage system 12) to generate a temperature gradient across the thermo-acoustic system, which then generates acoustic waves and that can be applied on the piezoelectric system to generate the electrical energy. In general, the piezoelectric system includes a device that comprises a series of parallel channels (or a stack) that is fixed in place at a location inside a tube (e.g., an open ended tube). Gas (or air) may be inserted into the tube. In a standing wave thermoacoustic wave generator, heat is delivered to the gas (within the tube) at the moment of greatest condensation, and taken from the tube at the moment of greatest rarefaction, thus generating a vibration(s). The vibrations cause a self-sustained oscillation which is then used to generate the electrical energy.

The electrical generation system 28 may provide the electrical energy to the secondary battery system 18. Such electrical energy can be stored therein during the hydrogen refueling operation. It is contemplated that the electrical generation system 28 may use only 10% of the released heat to generate the electrical energy. The electrical generation system 28 may deliver the unused heated coolant to the heat storage system 20 for storage purposes. In one example, the electrical generation system 28 may be located off-board 29 from the vehicle and may be used in connection with a refueling (e.g., hydrogen refueling) station. In another example, the electrical generation system 28 may be positioned within the vehicle.

The heat storage system 20 generally comprises a phase change material that is used to store heat from the coolant delivered from the electrical generation system 28. For example, the phase change material stores the heat in moments in which the temperature of the material is above a predetermined temperature. The phase change material is in liquid form when storing heat. The phase change material releases the stored heat when the temperature of the material falls below the predetermined temperature. The predetermined temperature may be a value that is between 10° C. to several hundred degrees centigrade. The phase change material solidifies when releasing the heat into the coolant. The phase change material may include, but not limited to, Dow LT1, erythritol, Ba(OH)2.8H₂O, DOW HT, DOW MT1, paraffin and PE. It is contemplated that the hydrogen storage system 12 may directly deliver the heated coolant to the heat storage system 20 (during refueling) for storage within the phase change material instead of the heated coolant being passed to the electrical generation system 28 and then having such heated coolant passed to the heat storage system 20.

Examples of various phase change materials and corresponding melting points are illustrated in the following table:

TABLE 1

| | Melting | Latent Heat | Density |
|---|---|---|---|
| Material | Point | Of Fusion (MJ/L) | (Kg/L) |
| Dow | 80° C.-600° C. | 1.20 | 5.2 |
| Azeotropic | | | |
| Fluids | | | |
| Water | 0° C. | 0.33 | 1.00 |
| Parrafin | 36 ° C.-45° C. | 0.18 | 0.78 |
| Wax | | | |
| Organic | 24° C.-80° C. | 0.35 | 1.50 |
| Salt | | | |
| Hydrated | 2° C.-90° C. | 0.21 | 1.50 |
| Eutectic | | | |
| Salts | | | |
| CaCl₂ | 24° C. | 0.21 | 1.47 |

Table 1 also provides the latent heat of fusion, which characterizes the heat storage capability of a phase change material in MJ/L, that is the heat (MJ) required to transfer a liter of a heat storage material into liquid at the melting point.

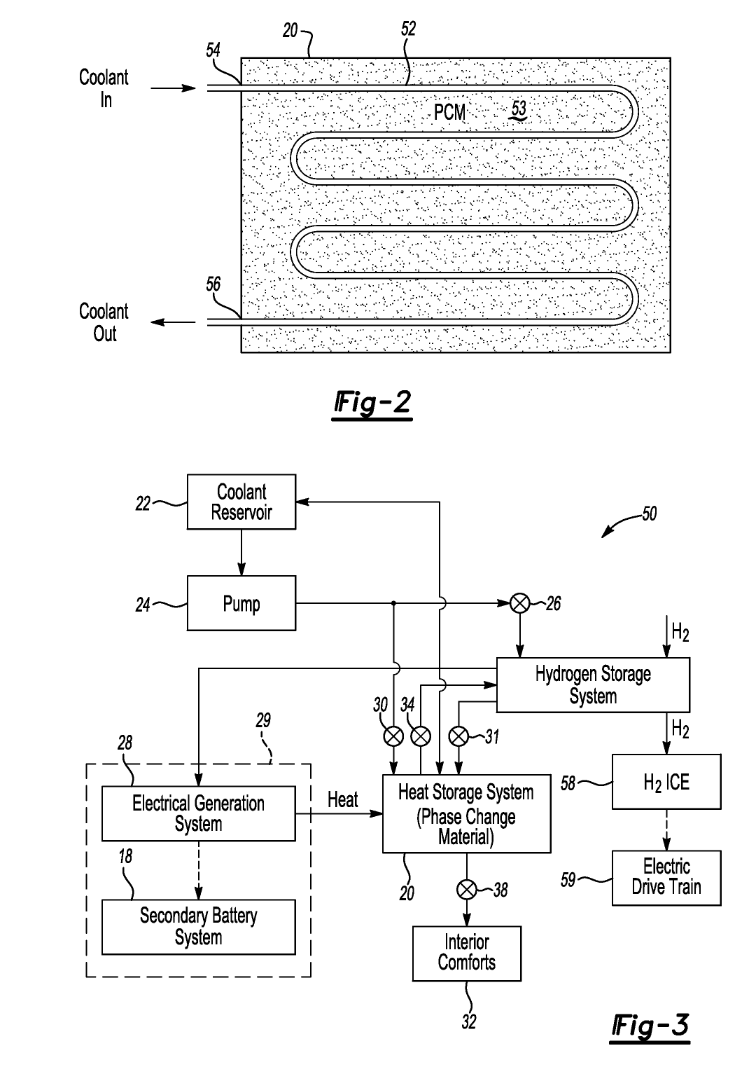

FIG. 2 depicts a more detailed diagram of the heat storage system 20. The system 20 is a vessel that includes a phase change material 53. A heat exchanger 52 is positioned within the system 20. The heat exchanger 52 is shaped in the form of a serpentine and is surrounded by the phase change material. The heat exchanger 52 includes an inlet 54 for receiving heated coolant from the electrical generation system 28 during the refueling operation. The serpentine shaped heat exchanger 52 enables the inlet 54 and the outlet 56 to be positioned on the same side of the heat storage system 20. A valve 31 (see FIG. 1) delivers heated coolant from the hydrogen storage system 12 to the inlet 54 during hydrogen absorption (e.g., hydrogen refueling). The heated coolant may also pass through the electricity generation system 28, and then flow into inlet 54 simultaneously. In another example, the heated coolant may pass through the electrical generation system 28 first, and then flow therefrom into the heat storage system 20. The heat exchanger 52 includes an outlet 56 for discharging coolant to the coolant reservoir 22, the hydrogen storage system 12 and/or the fuel cell stack 14.

The phase change material 53 stores the heat in the coolant that is delivered from the electrical generation system 28 and/or from the hydrogen storage system 12. As noted above, there could be up to about 90% of the released heat upon hydrogen refueling or exothermic hydrogen generation. As the temperature falls below the predetermined temperature (e.g., the melting point of the phase change material), the phase change material 53 discharges the heat to heat the coolant. The outlet 56 discharges the heated coolant to the hydrogen storage system 12 and/or the fuel cell stack 14.

It may be necessary to heat the hydrogen storage system 12 to move the hydrogen stored therein to the fuel cell stack 14 (e.g., hydrogen desorption). The heat provided by the heat storage system 20 can be used to enable hydrogen to be delivered to the fuel cell stack 14, particularly during fuel cell start-up when the fuel cell stack 14 is cold, and heat is needed to desorb hydrogen from hydrogen storage tank 12 to fuel the fuel cell stack 14. In addition, the heat provided by the heat storage system 20 can be used to prevent the fuel cell stack 14 from freezing, or to ensure that the fuel cell stack 14 operates at an optimum working temperature on board the vehicle when operating in a non-start-up mode (fuel cell stack generates fuel to drive vehicles) in moments in which the exterior temperature is low. An interior comfort system (e.g. heating ventilating and air conditioning (HVAC) system) 32 may also receive the heated coolant from the heated storage system 20 and use such heat to ward the interior of the vehicle. Valves 34, 36, 38 may be coupled to the outlet 56 of the heat storage system 20 to selectively control the flow of the coolant to the hydrogen storage system 12, fuel cell stack 14, and/or the interior comfort system 32. It is recognized that one or more controllers (not shown) may be operably coupled to the valves 26, 30, 34, and/or 36 to control the flow of coolant within the system 10.

During hydrogen desorption and in moments in which the weather is hot or warm, the hydrogen storage system 12 may still need heat from the heat storage system 20 to receive the hydrogen from the hydrogen storage system 12 to deliver to the fuel cell stack 14. In this scenario, the hydrogen storage system 12 discharges coolant that passes therethrough at temperatures that are less than the environment temperature and below the predetermined temperature. The heat storage system 20 receives the coolant (while at the cooler temperature) such that the phase change material discharge heat to the coolant to deliver to the hydrogen storage system 12 to enable the hydrogen desorption process to occur.

FIG. 3 depicts a system 50 for storing and discharging heat in the vehicle in accordance to one embodiment of the present invention. The system 50 includes a hydrogen based internal combustion engine (ICE) 58 and a drive system 59 (or drivetrain). The hydrogen ICE 58 uses hydrogen as opposed to gasoline to drive the drive system 59. In one example, the secondary battery system 18 and the electrical generation system 28 may be positioned off board 29. In another example, either the secondary battery system 18 or the electrical generation system 28 may be positioned within the vehicle.

The electrical generation system 28 generates electrical energy that is stored on the secondary battery system 28. As noted in connection with FIG. 1, the electrical generation system 28 uses heat to generate the electrical energy. Various accessory devices that are positioned off of the vehicle may receive the electrical energy. In a similar manner to that described above in connection with FIG. 1, the electrical generation system 28 provides heated coolant to the heat storage system 20 to store the heat within the phase change material. The heat storage system 20 provides the heat (e.g., by way of coolant) to the hydrogen storage system 12 when needed. The heat provided by the heat storage system 20 can be used to enable hydrogen to be delivered to the hydrogen ICE 58. As noted above in connection with FIG. 1, the heat storage system 20 may provide heat to the hydrogen storage system 12 during the hydrogen desorption process to enable the delivery of hydrogen to the hydrogen ICE 58 in both hot and cold weather conditions. The heat storage system 12 also provides heat to the interior comfort system 32.

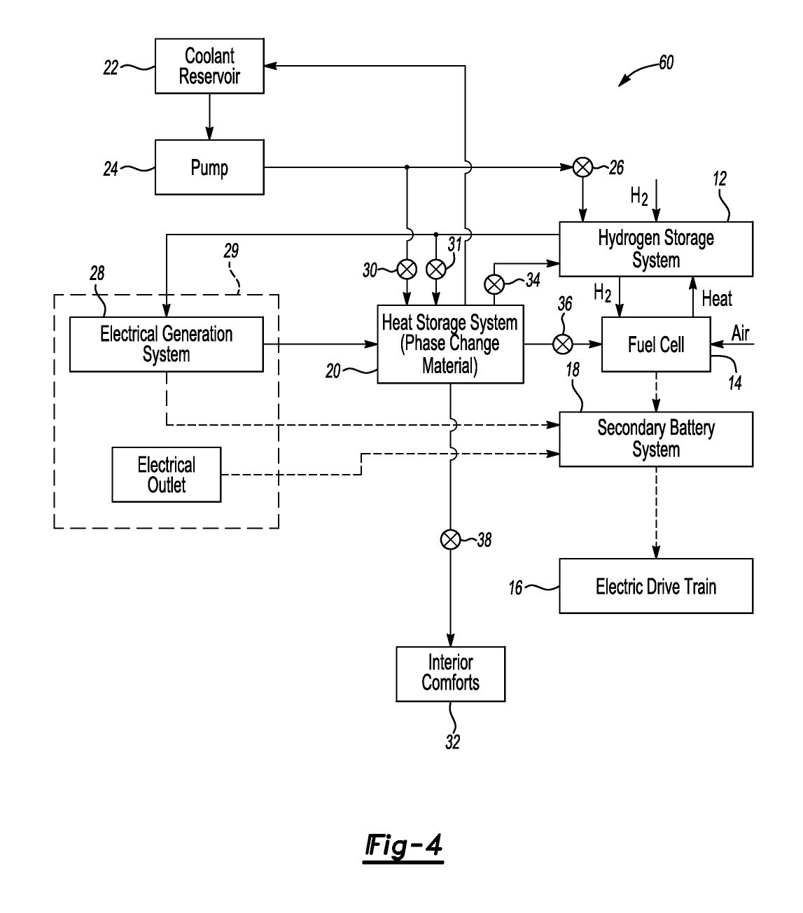

FIG. 4 depicts a system 60 for storing and discharging heat in a vehicle in accordance to one embodiment of the present invention. In general, the system 60 is similar to the system 20 as depicted in connection with FIG. 1 with the exception of the fuel cell stack 14 being electrically coupled to the secondary battery system 18. The fuel cell stack 14 generates the electrical energy in response to electrochemically converting hydrogen and oxygen. The secondary battery system 18 stores the electrical energy from the fuel cell stack 14 and drives the electrical drive train 16 with the same. An electrical outlet 62 is positioned off board 29 and operatively coupled to a power supply (not shown) (e.g., at a recharging station). The electrical outlet 62 transfers power off board 29 back to the battery system 18. The electrical generation system 28 may also transfer electrical energy to the secondary battery system 18. The secondary battery system 18 may drive the electric drive train 16 with the electrical energy that is received from the electrical generation system 28 and/or the electrical outlet 62 as well as from the fuel cell stack 14. The system 60 may be implemented as a plug-in hydrogen hybrid vehicle.

As noted above, the heat storage system 20 includes a phase change material for storing heat and releasing heat into the coolant that is passed therethrough when the temperature of the phase change material falls below the predetermined temperature. Such heat may be delivered to the hydrogen storage system 12, the fuel cell stack 14, and/or the interior comfort system 32 in the manner described above.

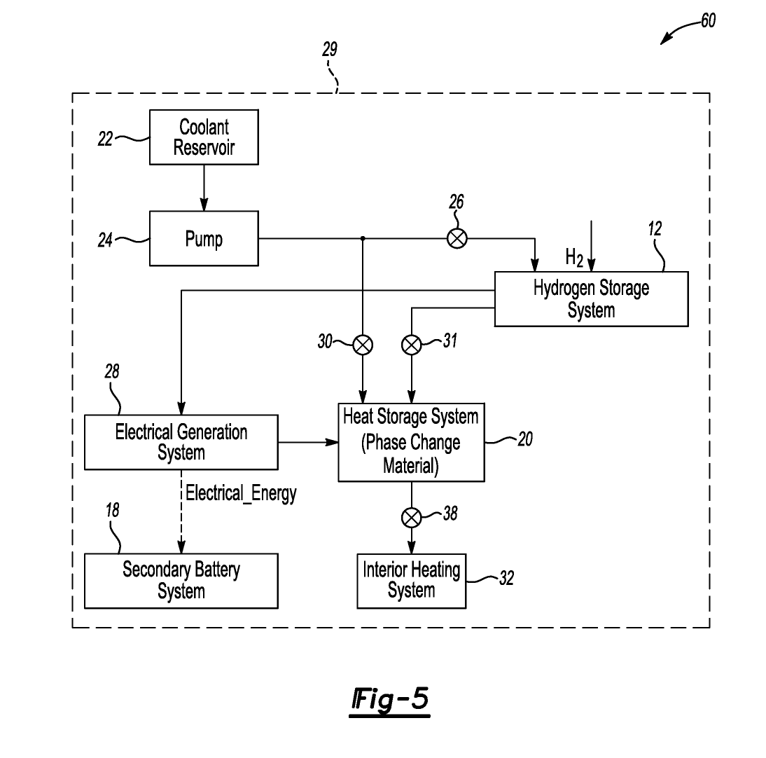

FIG. 5 depicts a system 70 for storing and discharging heat off-board 29 the vehicle in accordance to one embodiment of the present invention. In general, the operation of the system 70 has been described above and its application may be suited for the off-board 29 implementation. The heat storage system 20 may provide heat within the coolant to the interior (or residential) comfort system 32. The secondary battery system 18 may store the electrical energy and provide the same for residential purposes.

While embodiments of the present invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. An apparatus comprising:
a hydrogen storage system being configured to store hydrogen and to deliver a first heated fluid stream to an electrical generation system that generates a second heated fluid stream and electrical energy in response to the first heated fluid stream; and
a heat storage system including a phase change material and being in fluid communication with the electrical generation system to deliver heat from the second heated fluid stream to a fuel cell stack.

2. The system of claim 1 wherein the phase change material is configured to:
store the heat from the second heated fluid stream in response to a temperature of the phase change material being above a predetermined temperature; and
discharge the heat in response to the temperature of the phase change material being below the predetermined temperature such that the heat storage system delivers the heat to the fuel cell stack.

3. The system of claim 1 wherein the heat storage unit is configured to deliver the heat from the second fluid stream to the hydrogen storage system to release stored hydrogen from within the hydrogen storage system to the fuel cell stack.

4. The system of claim 3 wherein the phase change material is configured to store the heat from the second heated fluid stream in response to a temperature of the phase change material being above a predetermined temperature; and
discharge the heat in response to the temperature of the phase change material being below the predetermined temperature such that the heat storage system delivers the heat to the hydrogen storage system.

5. The system of claim 1 wherein the heat storage unit is configured to deliver the heat from the second fluid stream to an interior comfort system to heat an interior of a vehicle.

6. The system of claim 5 wherein the phase change material is configured to:
store the heat from the second heated fluid stream in response to a temperature of the phase change material being above a predetermined temperature; and
discharge the heat in response to the temperature of the phase change material being below a predetermined temperature such that the heat storage system delivers the heat to the interior comfort system.

7. The system of claim 1 wherein the electrical generation system comprises one of a thermophotovoltaic device and a combination of a thermoacoustic and piezoelectric device for generating the electrical energy in response to the first heated fluid stream.

8. The system of claim 7 further comprising a battery system being electrically coupled to the electrical generation system for storing the electrical energy.

9. The system of claim 1 wherein the phase change material comprises a Dow azeotropic fluid.

10. A vehicle system comprising:
a hydrogen storage system being configured to store hydrogen and to deliver a first heated fluid stream to an electrical generation system that generates a second heated fluid stream and electrical energy in response to the first heated fluid stream; and
a heat storage system including a phase change material and being in fluid communication with the electrical generation system for receiving the second heated fluid stream, the phase change material being configured to store the heat from the second heated fluid stream if a temperature thereof is above a predetermined temperature and to discharge the heat if the temperature thereof is below the predetermined temperature.

11. The system of claim 10 wherein the heat storage system is configured to deliver the discharged heat to the hydrogen storage system to release stored hydrogen from therein to a one of fuel cell stack and a hydrogen based internal combustion engine.

12. The system of claim 10 wherein the heat storage system is configured to deliver the discharged heat to a fuel cell stack.

13. The system of claim 10 wherein the heat storage system is configured to deliver the discharged heat to an interior comfort system to heat an interior of the vehicle.

14. The system of claim 10 wherein the electrical generation system comprises one of a thermophotovoltaic device and a combination of a thermoacoustic and piezoelectric device for generating the electrical energy in response to the first heated fluid stream.

15. The system of claim 14 further comprising a battery system being electrically coupled to electrical generation system for storing the electrical energy.

16. The system of claim 10 wherein the phase change material comprises a Dow azeotropic fluid.

17. A vehicle system comprising:
a hydrogen storage system being configured to store hydrogen and to deliver a first heated fluid stream to an electrical generation system that generates a second heated fluid stream and electrical energy in response to the first heated fluid stream; and
a heat storage system including a phase change material and being in fluid communication with the electrical generation system to deliver heat from the second heated fluid stream to the hydrogen storage system to discharge the stored hydrogen as fuel to one of a fuel cell stack and a hydrogen based internal combustion engine.

18. The system of claim 17 wherein the phase change material is configured to:
store the heat from the second heated fluid stream in response to a temperature of the phase change material being above a predetermined temperature; and
discharge the heat in response to the temperature of the phase change material being below the predetermined temperature such that the heat storage system delivers the heat to the hydrogen storage system.

19. The system of claim 17 wherein the heat storage unit is configured to deliver the heat from the second fluid stream to the fuel cell stack.

20. The system of claim 17 wherein the heat storage unit is configured to deliver the heat from the second fluid stream to an interior comfort system to heat an interior of the vehicle.
